(19) United States
(12) Patent Application Publication
(10) Pub. No.: US 2021/0015121 A1
(43) Pub. Date: Jan. 21, 2021

(54) Products Comprising Plant-Based Micro Fibers

(71) Applicant: WARNER BABCOCK INSTITUTE FOR GREEN CHEMISTRY, LLC, Wilmington, MA (US)

(72) Inventors: John C. Warner, Wilmington, MA (US); Justin Whitfield, Wilmington, MA (US); Richard M. Allen, Wilmington, MA (US); Dwight Tschudy, Wilmington, MA (US)

(73) Assignee: WARNER BABCOCK INSTITUTE FOR GREEN CHEMISTRY, LLC, Wilmington, MA (US)

(21) Appl. No.: 16/766,818

(22) PCT Filed: Nov. 30, 2018
(86) PCT No.: PCT/US2018/063228

§ 371 Date: May 26, 2020

Related U.S. Application Data
(60) Provisional application No. 62/592,735, filed on Nov. 30, 2017.

(51) Int. Cl. A23K 20/163; A23K 20/28; A23K 50/42; A23K 10/20

(52) U.S. Cl. CPC A23K 20/163; A23K 10/20; A23K 50/42; A23K 20/28

(57) ABSTRACT

Provided herein is a composition comprising a deliverable substance in a matrix for controlled delivery. The composition comprises cellulose micro fibers (“CMF”), an inert particle substance, and a deliverable substance. This general formula may be applied to a wide range of products, as discussed in detail below. For example, described herein are dog treat compositions comprising cellulose micro fibers which are a substitute for rawhide dog chews. Dog treats made as described herein are very durable and have a wide spectrum of possible sizes, flavors and properties.

### SUMMARY

Provided herein is a composition comprising a deliverable substance in a matrix for controlled delivery. The composition comprises cellulose micro fibers (“CMF”), an inert particle substance, and a deliverable substance. This general formula may be applied to a wide range of products, as discussed in detail below. For example, described herein are dog treats comprising cellulose micro fibers which are a substitute for rawhide dog chews. Dog treats made as described herein are very durable and have a wide spectrum of possible sizes, flavors and properties.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

Numerical ranges, measurements and parameters used to characterize the invention—for example, angular degrees, quantities of ingredients, polymer molecular weights, reaction conditions (pH, temperatures, charge levels, etc.), physical dimensions and so forth—are necessarily approximations; and, while reported as precisely as possible, they inherently contain imprecision derived from their respective measurements. Consequently, all numbers expressing ranges of magnitudes as used in the specification and claims are to be understood as being modified in all instances by the term “about.” All numerical ranges are understood to include all possible incremental sub-ranges within the outer boundaries of the range. Thus, a range of 30 to 90 units discloses, for example, 35 to 50 units, 45 to 85 units, and 40 to 80 units, etc. Unless otherwise defined, percentages are wt/wt %.

The term “cellulose micro fibers” (or “CMF”) as used herein refers to lyophilized cellulose fibers prepared using a process such as that described in U.S. Patent Application Publication No. 2015/0167243 A1 (final product referred to therein alternatively as “nanocellulose fibers”, “cellulose nanofibers”, “cellulose nanofibrils”, “CNF”, “nanofibrillated cellulose (NFC)” or “microfibrillated cellulose (MFC)” instead of “CMF”). Material as described therein was obtained from Southworth/Paper Logic, Turners Falls, Mass. Individual CMF fiber length is in some cases as long as 1 mm. CMF fiber bundle and individual fiber diameter may vary but generally measures from about 1 to 0.05 μm. Surface area (calculated using Brunauer-Emmett-Teller (BET) analysis for absorbed gasses) was 12.1 m²/g. Sample was 0.15 g of lyophilized and milled CMF on a Micromeritics TriStar II Plus instrument.

Provided herein is a matrix-controlled delivery system for delivering a deliverable substance, the system comprising a networking agent, an inert particle substance, and the deliverable substance. The networking agent may be cellulose microfibers (CMF).

Also provided herein is a process for formulating a composition comprising a deliverable substance in a matrix for controlled delivery, the process comprising the steps of forming an aqueous solution comprising a networking agent, an inert particle substance, and the deliverable substance. The networking agent may be cellulose microfibers (CMF). The inert particle substance may be selected from the group consisting of cellulosic material, sand, silica, and metal oxides such as titanium dioxide, zirconium dioxide and the like. The deliverable substance may be selected from the group consisting of flavorings, pharmaceuticals, and softening agents.

The composition described herein may further comprise an additive. Suitable additives may be selected from the group consisting of pharmaceutically acceptable excipients, carriers, diluents, fillers, polymers, permeation enhancers, solubilizers, adjuvants, binders, lubricants, dispersing agents, disintegrants, sweeteners, flavoring agents, dyes, emulsifiers, suspending agents, surfactants, detackifiers, anti-foaming agents, buffering agents, antioxidants, preservatives, chelating agents, viscomodulators, tonicifiers, pigments, colorants, odorants, opacifiers, plasticizers, seeds (e.g., grass, flax, sunflower, pumpkin and the like) and mixtures thereof.

The process of making a composition described herein may further comprise the step of drying the aqueous solution. Suitable methods of drying the aqueous solution are known in the art.

The hardness of the composition, and/or the rate of controlled release of a deliverable substance from the composition produced according to the methods described herein may be controlled by varying the relative concentrations of the networking agent and inert particle substance.

In addition to the general methods described in U.S. Patent Application Publication No. 2015/0167243 A1, CMF may also be prepared using a process which comprises the steps of: (1) providing a cellulosic material; (2) treating the cellulosic material with an aqueous slurry containing a depolymerizing agent selected from (a) ozone at a charge level of at least about 0.1 wt/wt %, based on the dry weight of the cellulosic material for generating free radicals in the slurry; (b) a cellulase enzyme at a concentration from about 0.1 to about 10 lbs/ton based on the dry weight of the cellulosic material; or (c) a combination of both (a) and (b), under conditions sufficient to cause partial depolymerization of the cellulosic material; and (3) concurrently or subsequently comminuting the cellulosic material to liberate cellulose microfibers.

In some of these CMF preparation methods, the treatment step is performed concurrently with the comminution step. In other embodiments, the treatment step is performed prior to the comminution step, making it a “pretreatment” step.

An exemplary product that can be produced according to the steps and parameters described herein is a dog treat. The present inventors have surprisingly discovered that a dog treat composition comprising CMF can be created using all-natural and edible ingredients. The resulting dog treat is tough, but will eventually soften upon repeated chewing. It can be shaped into almost any shape and size to meet the design parameters such as large and small dogs.

Additives can be incorporated to increase nutritional value, medicinal value, taste appeal, odor appeal, and to reduce overall materials cost.

Dog treats as described herein may have a CMF content of about 10 to about 90%. Generally, a composition which includes less CMF will have a softer texture than one with more CMF. A content of about 70 to about 90% CMF will produce a dog chew of a hardness similar to a traditional rawhide dog treat. The dog treats may comprise one or more additives, which may be present in an amount of about 0.1 to about 90% of the composition. Exemplary additives for use in dog treats may include, but are not limited to, bacon, tallow, alginate, starch, gelatin, and/or casein. Other additives which may be incorporated into the dog treats include vitamins, nutraceuticals such as chondroitin and/or flax, other carbohydrates such as sugars and/or starches, proteins such as whey, amino acids, fats such as peanut oil; omega-3 fatty acids, medicinal ingredients such as anti-tick and/or anti-flea compounds, fruit and/or vegetables such as spinach, sweet potato, and apples, and flavorings such as cinnamon or mint.

In some embodiments, the dog treats as described herein have the following composition (percentages by final dry weight): CMF (75 to 90%); alginate (1 to 5%); flavoring (2 to 15%); and other additives (0 to 15%).

CMF may also be added to sand for use in construction applications. When combined with sand, CMF may be present in amounts up to 95%. When the CMF/sand mixture is to be used to fabricate a solid material, CMF may advantageously be present in a concentration of about 5 to about 20%.

When added to a plaster composition, CMF will improve the insulating properties of the resulting plaster, due to the lower density of the final product. A CMF/plaster mixture will also produce less dust than a conventional plaster composition. CMF may be advantageously present in in a concentration of up to about 10%; when used in a concentration of about 3 to about 4%, the density of the CMF/plaster mixture will be about 0.6 g/cm³, as compared to conventional plaster without CMF, which has a density of about 1.2 g/cm³.

CMF may also be added to silica gel for use in thin layer chromatography (TLC). CMF may be added to silica gel in a concentration of up to 90% CMF; advantageously, CMF may be added to silica gel in a concentration of about 10% to about 20%.

CMF may also be added to synthetic wood products comprising wood flour, wood fiber, paper pulp, other plant fibers or powders (e.g., eucalyptus, cotton, jute, sisal, hemp, bamboo) to form boards which may be substituted for ordinary boards and for other synthetic wood products. For use in fabricating boards, CMF may be added to the composition in an amount of about 10% to about 90%. CMF may advantageously be added to a composition to fabricate solid boards in an amount of about 10% to about 30%. Compositions with more CMF will result in stronger boards.

CMF may also be employed as a fluid modifier, when added to compositions comprising a base material such as polyvinylbutyral (PVB), acrylics, latex, and other paints, inks, and pigments. When added to a composition as a fluid modifier, CMF may be present in a concentration of about 0.1% to about 90% of the composition. For example, the addition of CMF to a PVB dispersion in an amount of about 0.5% to about 2.5% will advantageously modify the compressive strength of the composition. CMF may also be added to latex paint in an amount of about 0.1% to about 1% of the composition to advantageously modify viscosity and gloss values.

CMF may also be added to polymers to form a composite material, such as polyethylene or nylon. CMF may be advantageously used in polymer composites in amounts from about 1% to about 90%. A composite of CMF and a thermo processible polymer may be used for any purpose for which the polymer alone is used, for example, in lumber substitutes.

CMF may also be added to a composition which comprises an active ingredient which is intended for controlled release. Examples of such active ingredients include pharmaceuticals, nutraceuticals, herbicides, pesticides, or other biologically active agents. For use in a controlled release formulation, CMF may advantageously be present in the composition in an amount of about 1% to about 99%.

CMF may also be used in an insulation composition, in amounts of up to 100%. CMF may be mixed with another material, such as organic or inorganic fillers, which may modify the strength and density of the resulting composition. For use in insulation, CMF may be used in lyophilized form. When CMF is used in lyophilized form, additives may be employed, such as gelatin, or alginate. Adding gelatin to lyophilized CMF increases the compressive strength of the composition.

### EXAMPLES

### Example 1: Dog Chew or Dog Treat Recipe

400 g of condensed CMF dough (˜17% solids) is placed into a mixer bowl. 2 g of alginate powder is added. The dough is mixed well until all alginate is thoroughly mixed. Dough should get more elastic. 4 g of bacon powder and 4 g of bacon bits are added and mixed well to disperse all bacon bits evenly throughout dough. The dough is then removed and formed into desired shape, being careful to not have visible cracks. The diameter or thickness of any part is kept to 1.5 inches or less. The composition is slowly dried in an oven or under ambient conditions until there is no additional weight loss.

This recipe will result in a final “bone” weight of about 78 g. The dry weight percentages will be: 87.2% CMF, 2.6% alginate, 5.1% bacon powder, 5.1% bacon bits.

Elasticity additive: In this recipe, alginate is used as the primary elasticity agent to reduce the cracking of the formed bone, but other food grade materials such as gums (guar, xanthan, locust bean, carrageenan, gelatin) may also be effective.

Flavorings: Bacon has been used which provides the smell and flavor that seems to be attractive to canines. Any other flavor additive approved for pet use can be used.

Other additives: Other fillers such as starch and beef tallow may also used. The CMF is versatile that nutritional or filler additives (proteins, carbohydrates, fiber, fats, vegetables, minerals) could be used. Medicinal additives should also be compatible with this system (vitamins, chondroitin, pharmaceuticals).

### Mechanical Testing (3-Point Bend)

| Formulation | Mas Stress (N/mm²) |
|---|---|
| 100% CMF | 28.6 |
| 75% CMF/25% cornstarch | 24.8 |
| 50% CMF/50% cornstarch | 11.8 |

### 24-Hour Swelling in Water

| Formulation | | Time: 0 | | | Time: 6 hr | | | Time: 26 hr | | |
|---|---|---|---|---|---|---|---|---|---|---|
| CMF: | | Length | Width | Thickness | Length | Width | Thickness | Length | Width | Thickness |
| Cornstarch | Format | (mm) | (mm) | (mm) | (mm) | (mm) | (mm) | (mm) | (mm) | (mm) |
| 100:0 | Disc | 20.8 | 19.7 | 6.9 | 22.6 | 21.5 | 8.1 | 25.2 | 23.8 | 8.1 |
| 75:25 | Disc | 20.6 | 17.9 | 9.6 | 24.8 | 20.8 | 11.1 | 26.2 | 22.2 | 11.3 |
| 75:25 | Rectangle | 28.9 | 23.3 | 10.0 | 29.0 | 23.1 | 11.1 | 31.5 | 25.5 | 12.4 |
| 25:75 | Disc | 23.5 | 21.9 | 8.8 | 33 | 27 | 9.7 | N/A | N/A | 9.8 |

Note:
at 26 h the 100% CMF was still solid, but it could be broken in half with just fingers.

What is claimed is:

1. A process for formulating a deliverable substance in a matrix for controlled delivery, the process comprising the step of forming an aqueous solution comprising cellulose microfibers (CMF), an inert particle substance, and a deliverable substance.

2. The process of claim 1 wherein the CMF is present in an amount of up to about 10% by weight.

3. The process of claim 1, wherein the inert particle substance is selected from the group consisting of cellulosic material, sand and silica.

4. The process of claim 3, wherein the inert particle substance is present in an amount of at least about 50% by weight.

5. The process of claim 1 wherein the deliverable substance is selected from the group consisting of flavorings, pharmaceuticals, softening agents.

6. The process of claim 1 wherein the aqueous solution further comprises an additive.

7. The process of claim 6, wherein the additive is selected from the group consisting of pharmaceutically acceptable excipients, carriers, diluents, fillers, permeation enhancers, solubilizers, adjuvants, binders, lubricants, dispersing agents, disintegrants, sweeteners, flavoring agents, dyes, emulsifiers, suspending agents, surfactants, detackifiers, anti-foaming agents, buffering agents, antioxidants, preservatives, chelating agents, viscomodulators, tonicifiers, colorants, odorants, opacifiers, plasticizers, and mixtures thereof.

8. The process of claim 1 further comprising the step of drying the aqueous solution.

9. A process for adjusting the hardness of a matrix-controlled delivery system, the process comprising the steps of:
(a) forming an aqueous solution comprising CMF, an inert particle substance, and an additive:
(b) drying the solution to form a matrix; and
(c) varying the amount of the CMF agent and the inert particle substance to control the hardness of the matrix.

9. A process for adjusting the rate of controlled release of a deliverable substance from a matrix-controlled delivery system, the process comprising the steps of:
(a) forming an aqueous solution comprising CMF, an inert particle substance, and the deliverable substance;
(b) drying the solution to form a matrix; and
(c) varying the amount of the CMF agent and the inert particle substance to control the rate of controlled delivery of the matrix.

10. A matrix-controlled delivery system for delivering a deliverable substance, the system comprising a networking agent, an inert particle substance, and the deliverable substance.

11. A matrix-controlled delivery system for delivering a deliverable substance, the system comprising a networking agent, an inert particle substance, and the deliverable substance, wherein the system is made by the process of claim 1.

12. A dog treat comprising CMF.

13. The dog treat of claim 12, wherein the CMF content is from about 10% to about 90% of the final dry weight of the composition.

14. The dog treat of claim 13, wherein the CMF content is from about 70% to about 90% of the final dry weight of the composition.

15. The dog treat of claim 12, further comprising one or more additives, which are present in an amount of about 0.1 to about 90% of the final dry weight of the composition.

16. The dog treat of claim 15, wherein the one or more additives are selected from the group consisting of bacon, tallow, alginate, starch, gelatin, casein, vitamins, nutraceuticals, other carbohydrates, proteins, amino acids, fats, omega-3 fatty acids, medicinal ingredients, fruit, vegetables, and flavorings.

17. The dog treat of claim 12, comprising, by final dry weight of the composition:
about 75% to about 90% CMF;
about 1% to about 5% alginate; and
about 2% to about 15% flavoring.

18. The dog treat of claim 17, further comprising about 1% to about 5% of bacon powder and about 1% to about 5% of bacon bits.

19. The dog treat of claim 12, further comprising one or more elasticity agents selected from the group consisting of alginate and gum.

20. The dog treat of claim 19, wherein the gum is selected from the group consisting of guar, xanthan, locust bean, carrageenan, and gelatin.
